(19) United States
(12) Patent Application Publication
(10) Pub. No.: US 2012/0271721 A1
(43) Pub. Date: Oct. 25, 2012

(54) Sharing affiliate revenue with user browsing website

(76) Inventor: Miteshkumar Mahendrabhai Bilimoria, Aurora, IL (US)

(21) Appl. No.: 13/542,709

(22) Filed: Jul. 6, 2012

Related U.S. Application Data
(63) Continuation-in-part of application No. 13/135,619, filed on Jul. 11, 2011.
(60) Provisional application No. 61/399,467, filed on Jul. 12, 2010.

(51) Int. Cl. G06Q 30/02

(52) U.S. Cl. 705/14.69

(57) ABSTRACT

Presented herein is a web browser. The web browser has a small window for showing affiliate programs. Advertisers will be able to pay on a “by the action” basis, because the advertisers will know precisely what activities were completed by user. The publisher can maintain the browser/browser extension and transmit relevant affiliate programs based on user data, behavior and the website user is visiting. The publisher can share part of the revenue generated from advertiser's affiliate programs with the users. The software/browser extension can help users to share links with other users and get more revenue.

### CLAIM OF PRIORITY

This application is a continuation in part and claims priority to “Sharing advertising revenue with user browsing website”, Utility Application for U.S. patent application Ser. No. 13/135,619, filed Jul. 12, 2011, which claims priority to provisional application 61/399,467 filed on Jul. 12, 2010 by reference for all purposes in their entirety.

### BACKGROUND OF THE INVENTION

Internet has revolutionized the advertising industry. Advertisers use the internet to market their products and services online. Most of the time users ignore the advertisements displayed as they may not be relevant. Additionally users do not get any monetary incentive to take interest in an advertiser's products or services.

### SUMMARY OF INVENTION

Embodiments presented herein can provide a platform to share affiliate links with the users and earn based on the actions taken by the users. Advertisers can pay a publisher and the publisher can share the revenue with the users who share the link.

### BRIEF DESCRIPTION OF DRAWINGS

FIG. 1 is a diagram of an exemplary web page where the users can be provided with information and medium to get started

FIG. 2 is an exemplary registration form for the users;

FIG. 3 is an example of the web page showing how the software can be downloaded;

FIG. 4 is a diagram showing an example of how the browser looks after the software/browser extension is installed;

FIG. 5 is a diagram of an exemplary dashboard where the users can check and withdraw their earnings;

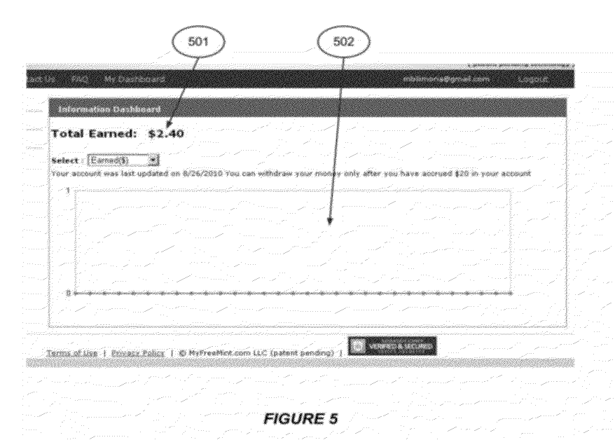

FIG. 6 is a diagram of an exemplary web page to create an affiliate program for an advertiser;

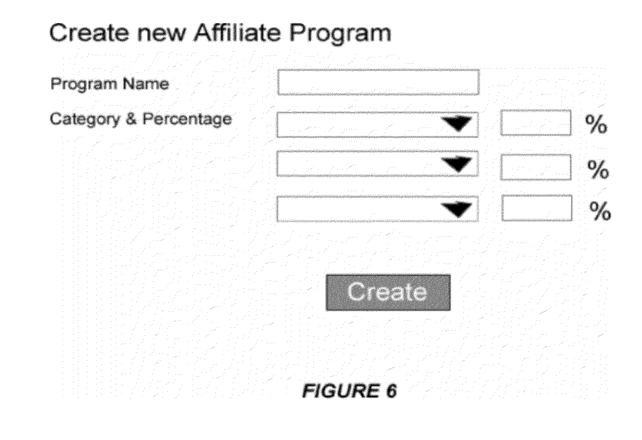

FIG. 7 is a flow diagram for an exemplary affiliate network and the user;

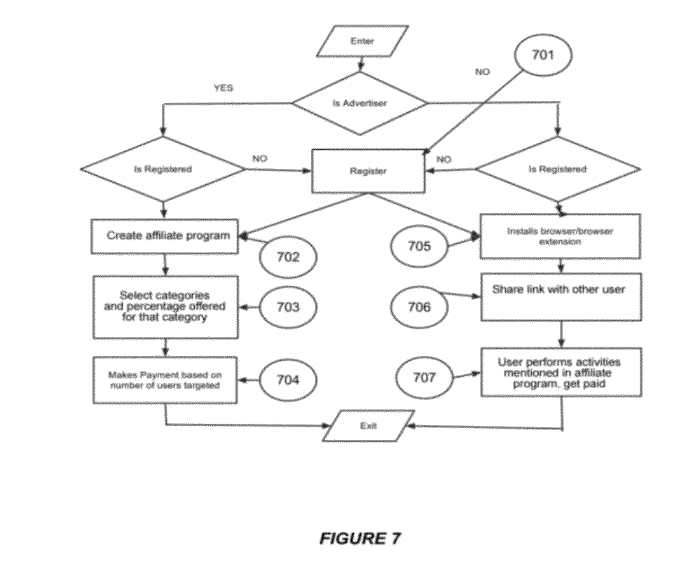

FIG. 8 is a diagram of exemplary database;

FIG. 9 is an exemplary overall system diagram;

FIG. 10 is a flow diagram of an example of how an affiliate gets selected;

FIG. 11 is an exemplary computer diagram on how data are stored and accessed; and

FIG. 12 is an exemplary sharing system diagram

### DESCRIPTION OF THE INVENTION

The World Wide Web has become basic requirement for everybody in the world. Normally people spend more than 13 hours per week of their time browsing through the different websites. People go to different websites based on their interest like news, products, video and many more.

Affiliate programs can be a very effective way of marketing products and services. Advertisers spend large amount of their revenue on online marketing. It would be advantageous for advertisers to have their daily deals, services and products to be published to as many users as possible with minimum investment.

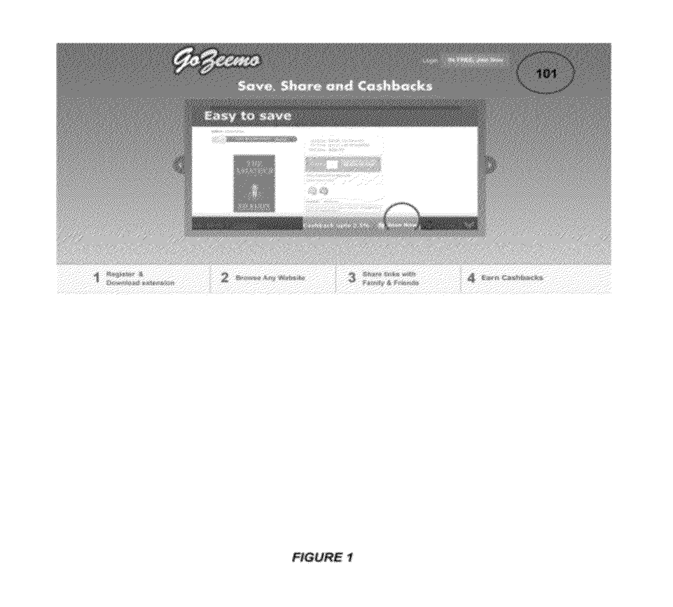

In one of the embodiment is a user network. The user can join the user network. Users can be provided with the user interface where they can get information about how to get started and this can be seen in FIG. 1. This user interface can guide users about how to earn money by just browsing and sharing links with other users. In FIG. 1 “Create New Account” button/link 101 can take a user to create their account and download software or a browser extension.

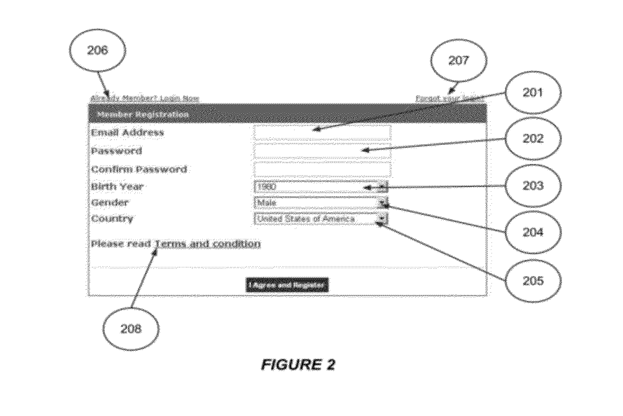

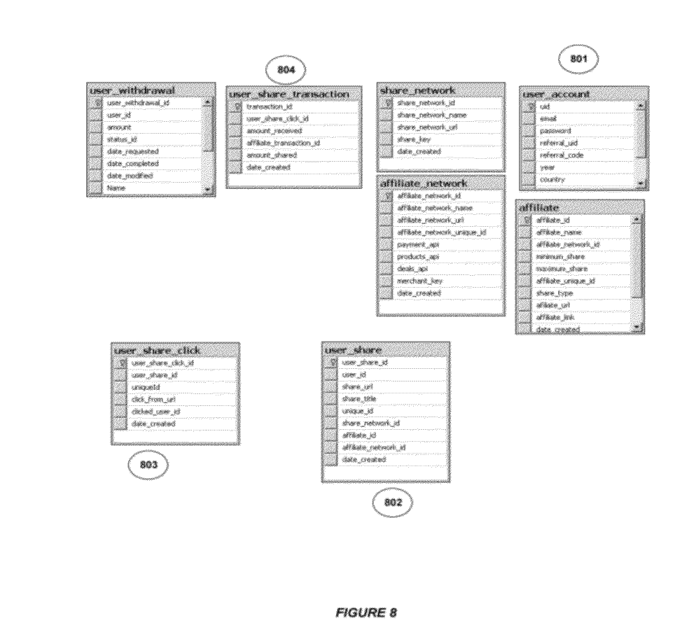

In FIG. 2, a user can enter their email address 201, password 202, birth year 203, gender 204 and country 205. Once they click on “I agree and register”, the system can insert record into user_account database table as shown in FIGS. 8-801. Users can enter more demographic and personal interest information after registration is complete.

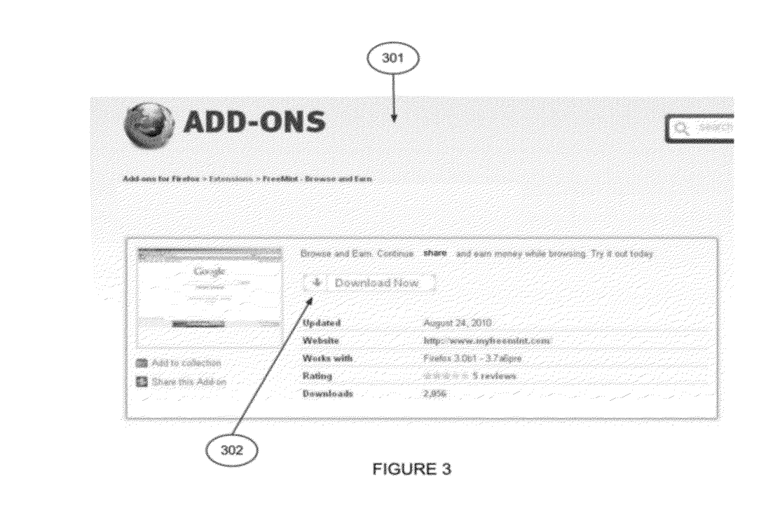

In FIG. 3, clicking on “download now” link 302 can download software or browser extension on the user's electronic device. Once software is downloaded, website will guide user to install it.

Another embodiment is an affiliate network. Advertisers will be provided with a medium to create affiliate programs. Publishers can also connect to advertisers through other affiliate networks. The affiliate network can be used as medium to connect the users to the advertisers.

Another embodiment is a publisher network. The publisher network can serve as a mediator between the affiliate network and the users. Publisher can maintain a software or browser extension that the users can download. The publisher can provide a website to allow users to check and withdraw funds from their account. A publisher can help the advertisers to set up their affiliate programs. A Publisher can also maintain an algorithm that will decide which affiliate program will be displayed to the user.

Another embodiment is a sharing network. The sharing network will be used by the users to share links of the website with their personal network e.g. family, friends, contacts etc. Once link is posted by the user on sharing network, anybody can click on and access the link.

After installation of the software or browser extension, users can see different areas on their electronic device.

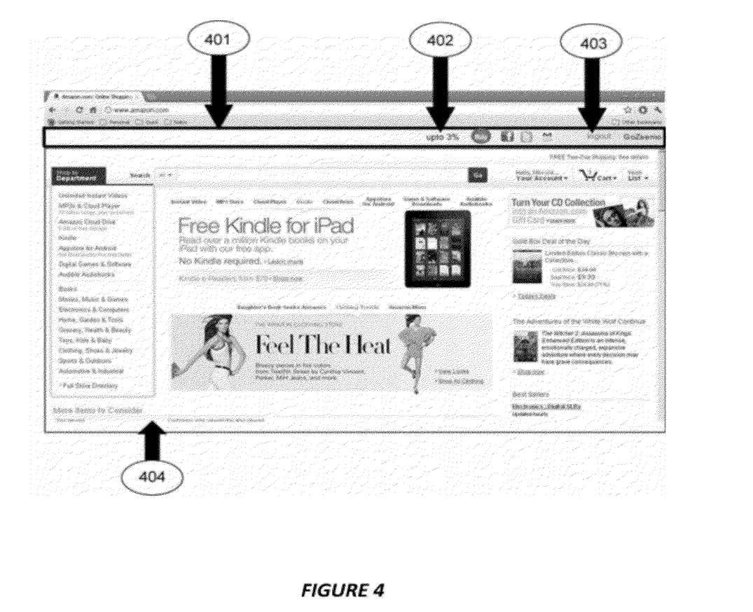

Users can continue browsing different websites, and that website can be displayed, for example, in one of these areas FIGS. 4-404. Based on the website being browsed and the data provided by the users; share buttons, products, services can be displayed in other advertisement areas FIGS. 4-401.

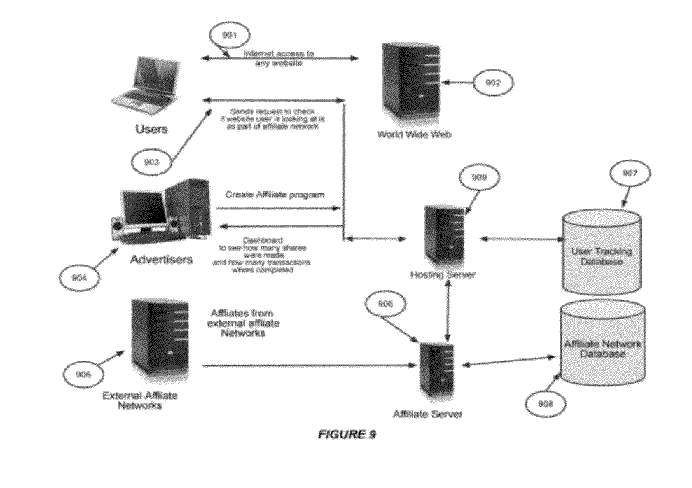

When the user starts browsing any website, two requests can be sent to World Wide Web by the browser. The first request can go to the website they are trying to browse FIGS. 9-901. Request can be loaded into display area FIGS. 4-404, without any modification. After the first request is loaded into display area 404, a second request can be sent to publisher FIGS. 9-903 from the software or browser extension. This request can include information about the first request loaded in 404 received and the user who has logged in. The request can be sent through the internet to hosting server FIGS. 9-909.

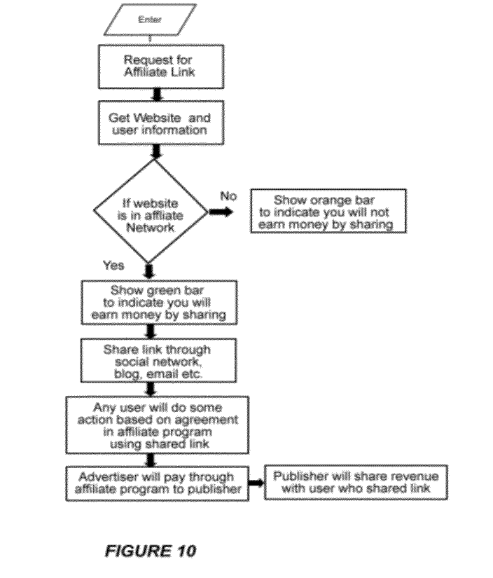

The hosting server 909 can receive the request from software or a browser extension. Hosting server can contact the advertising server or the affiliate network 906 and determine if they are part of the affiliate network as shown in FIG. 10.

As per FIG. 10, the advertising server can first check whether the website is a part of the affiliate network. If the website is part of the affiliate network it can create a confirmation window as in FIG. 4-401. The confirmation window can be a particular color, e.g., green. The confirmation window can display cashback percentage that can be shared and also display ways to share link on social network, blogs, email etc. User can also be given link to directly get affiliate network cashback, if the user himself/herself wants to buy that product or services and get cashback.

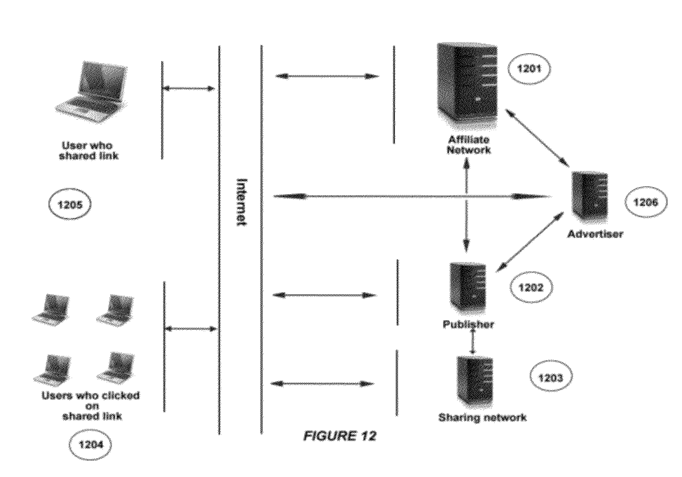

Once the user clicks on the “buy now” option, a request can be sent to the Publisher FIG. 12-1202 and the user can get directed to an affiliate network FIGS. 12-1201 or an advertiser website directly FIGS. 12-1206. Unique identifier is created in database FIGS. 8-802 and that can identify the user can be passed to the affiliate network or the advertiser.

If the user clicks on the “share now” option, then a separate request can be sent to the publisher FIGS. 12-1202 and the user can select which sharing network they want to share on. The user can be allowed to select an option to select sharing network FIGS. 12-1203 directly from browser extension. The user can then share link on sharing network FIGS. 12-1203. On sharing a unique identifier is created in database table FIGS. 8-802 and passed with sharing link. Any other user that clicks on link share by the user, can be redirected to the publisher network and an entry can be made into database table FIGS. 8-803. This database entry can tell the primary user that somebody clicked on link shared.

After that the secondary user who clicked on link can be redirected to the affiliate network or the advertiser directly. Once secondary user completes its activities prescribed by the advertiser, the affiliate network or the advertiser can send its payment to the publisher. The publisher can then add entry into database table FIG. 8-804. The publisher can share part of money received from the affiliate network or the advertiser with the user who shared link.

Once website is verified that it is part of the affiliate network, affiliate server 906 returns that back to the hosting server 909 which returns it back to software or a browser extension. Software or browser extension can then show that amount that can be shared along with ways to share that link to the user. Once links are displayed in advertisement display area FIGS. 4-401, the users can click on any of social network, blog, email etc to share link. Activities like click and share will be tracked in user tracking database 908.

The publisher can provide method for users to withdraw money from their account. Publisher can also have refer-a-friend program for users where the publisher can share extra amount if user refers to friends. This extra amount can be deposited in users account only if referred friend successfully joins publisher user network.

The publisher can provide method for advertisers to see activities on their affiliate program. It can also guide the advertisers on how to target more users. It can tell advertiser about how many users were targeted, what kind of interaction they did with affiliate program and what the success rate was.

Advertisers can be induced to use this method because they can increase their estimated return on investment (eROI) and drive more traffic to their websites.

Most companies do not allow any other products or services advertisement on their website. e.g Apple cannot allow Amazon to put advertisement of its product on their website. In this method can actually show competitors' products or services in advertisement window FIGS. 4-401. e.g if user is at Apple.com, Amazon can advertise their competitive product such as Kindle in advertisement window. This method gives advertisers opportunity which is not possible right now.

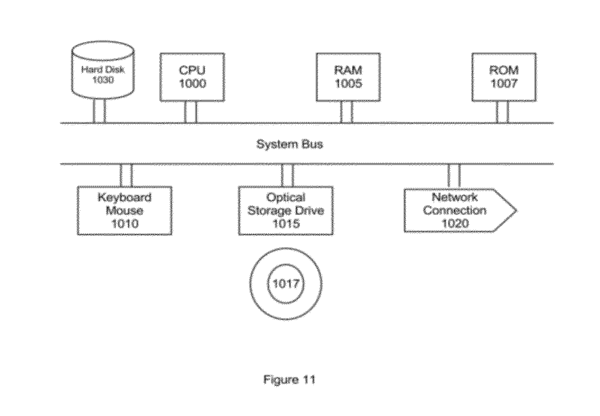

Referring now to FIG. 11, there is illustrated a block diagram of computer system. The computer system comprises a CPU 1000, Random Access Memory (RAM) 1005, Read Only Memory 10010, hard disk 1030, keyboard/mouse 1010, optical storage drive 1015 for accepting optical storage, such as Compact Disc or DVD 10110, and a network connection 1020. The foregoing care connected by a bus.

The CPU 1000 is configured to executed instructions that are resident in various memories in the computer system, including the hard disc 1030, and optical storage device 10110. The instruction can reside in the foregoing memories, while awaiting execution by the CPU 1000. The instructions can be transferred to the RAM 1005 executed by the CPU 1000.

The network connection(s) 1020 connects the computer to a network, such as the internet comprising other computers. The network connection(s) 1020 can comprise, but is not limited to, either a port connected by a cable, or wireless network connection, such as a (wireless fidelity) wi-fi connection, wireless local area network (WLAN), or cellular connection, to a network such as the internet.

One embodiment of the present invention can be a plurality of instructions stored in the optical storage 10110, hard disc 1030, RAM 1005 or a combination, thereof. The combination can also include optical storage 10110, hard disc 1030, RAM 1005 of an additional computer connected to the computer via the network connection 1020(s).

It is noted that in a certain embodiments of the invention, the computer system 1000 can be hand-held sized and equipped to maintain a phone conversation over network connection 1020.

It is noted that the storage of the instructions on the optical storage 10110, hard disc 1030, and RAM 1005 chemically, mechanically, electrically, and/or magnetically transform the optical storage 10110, hard disc 1030, and RAM 1005. In certain embodiments of the present invention, a computer system can be sold pre-loaded with the browser.

The foregoing illustrates exemplary embodiments of the present invention. It is noted, however, modifications and substitutions can be made without departing from the spirit of the invention. Accordingly, the invention is only limited by the following claims and equivalents thereof.

1. A method of web browsing, said method comprising:
providing sharing mechanism on a browser;
tracking usage of the browser by a user; and
paying the user based on activity completed by the user as prescribed by an affiliate network or an advertiser

2. The method of claim 1, further comprising receiving money for doing activity prescribed by the advertiser.

3. The method of claim 2, wherein paying the user comprises paying the user a portion of the money generated from the affiliate program

4. The method of claim 1, wherein the sharing link is displayed in separate portion of said browser and is different from the web page viewed by the user.

5. The method of claim 1, wherein providing the sharing link comprises transmitting advertisements from a dedicated mode that is different from a web site viewed by user.

6. A non-transitory computer-readable medium storing a plurality of instructions for:
generating a browsing window for displaying web pages selected by a user
establishing a connection with a predetermined affiliate server
generating another window for providing advertisements from the predetermined affiliate server;
tracking usage of the browsing window; and
causing payment to the user based on the activity prescribed by the affiliate network by using a link.

7. The non-transitory computer-readable medium of claim 6, wherein the plurality of instructions further comprise instructions for receiving money from affiliate network for completing activity as prescribed by the affiliate network.

8. The non-transitory computer-readable medium of claim 6, wherein paying the user comprises paying the user a portion of the money from the affiliate network.

9. The non-transitory computer-readable medium of claim 6, wherein the sharing mechanism is displayed in a separate portion of said browser and is different from the web page viewed by user.

10. The non-transitory computer-readable medium of claim 6, wherein providing advertisement comprises transmitting the advertisements from a dedicated mode that is different from a web site viewed by user.

11. A computer system, said computer system comprising:
a processor;
a screen connected to the processor;
a port connected to the processor, said port configured to establish a connection to a network;
a non-transitory computer-readable medium storing a plurality of instructions, connected to the processor, the plurality of instructions executable by the processor for:
generating a browsing window on the screen for displaying web pages selected by a user and received over the port;
establishing a connection with a predetermined affiliate server over the port;
generating another window on the screen for providing sharing mechanism from the predetermined affiliate server;
tracking usage of the browsing window; and
paying the user based on the activity prescribed by affiliate network.

12. The computer system of claim 11, wherein the plurality of instructions further comprise instructions for receiving money from affiliate network for completing activity prescribed by affiliate network.

13. The computer system of claim 11, wherein paying the user comprises paying the user a portion of the money from the affiliate network.

14. The computer system of claim 11, wherein the sharing mechanism is displayed in separate portion of said browser and is different from the web page viewed by user.

15. The computer system of claim 11, wherein providing sharing mechanism comprises transmitting the sharing links from a dedicated mode that is different from a web site viewed by user.
